(19) United States
(12) Patent Application Publication
(10) Pub. No.: US 2011/0320235 A1
(43) Pub. Date: Dec. 29, 2011

(54) COMPUTER CONTROLLED MEETINGS CALENDAR SCHEDULER BASED UPON IMPORTANCE OF MEETING ATTRIBUTES

(75) Inventors: Nathan Victor Bak, Portland, OR (US); Elizabeth Baruka Silberg, Beaverton, OR (US); Yelena Bayeva, Portland, OR (US); Sukadev Bhattiprolu, Beaverton, OR (US); Alexis Hope Bruemmer, Hillsboro, OR (US)

(73) Assignee: International Business Machines Corporation, Armonk, NY (US)

(21) Appl. No.: 12/822,772

(22) Filed: Jun. 24, 2010

(51) Int. Cl. G06Q 10/00

(52) U.S. Cl. 705/7.19

(57) ABSTRACT

An invitee who is receiving invitations to meetings, usually via telecommunication, is enabled to predetermine a set of invitee-specific attributes that will be applied to each invitation and to relate the attributes of the invitation to the specific needs of the invitee in the determination of whether the proposed meeting may be scheduled on the specific invitee's calendar.

### TECHNICAL FIELD

The present invention relates to the computer controlled scheduling of meetings on calendars. More particularly the invention relates to the automated scheduling of meetings on calendars and the organization of such calendars of invitees based upon the importance of a set of predetermined attributes of such meetings.

### BACKGROUND OF RELATED ART

Computer controlled organization and scheduling of meetings on users' calendars has been available to users for almost twenty years through a variety of application programs and operating systems.

However, with the development of the Internet and its attendant limitless facilities for electronic communication, the means by which day-to-day business and commerce are conducted has been dramatically changed. Business and commercial facilities and plants housing hundreds of employees at a single point have been giving way to workers operating individually or in small clusters at dozens of individual sites linked through the Internet and like networks. Businesses have been deciding that they may effectively reduce costs by eliminating many of their centralized facilities, as well as wasted time commuting to such facilities by employees. Increasingly, employees are enabled to work at home and communicate with each other and their management via communication networks. Also, the communication facilities offered by the Internet have driven electronic business, eBusiness and like methods wherein businesses outsource many of their functions to contracting and subcontracting businesses.

As a result of these dynamics, individuals and facilities that must coact in business and commercial functions are distributed worldwide; and business and commercial actions are being conducted worldwide and on a 24 hour around the clock schedule. To the individual worker linked to and involved in such 24 hour worldwide operations, there are resulting benefits and detriments. He or she is no longer tied to a regular facility and time bound functions often involving significant commuting times. The employee primarily has the responsibility of getting his or her job or task successfully completed on time. He or she may set their own daily schedule and dovetail such activities with their personal schedule. This is particularly important for childcare in two working parent and single parent households.

There can be, however, significant detriments. Because the employee is linked or tethered via their communication device to a global around the clock operation, their life could be continually intruded upon by attempts to schedule meetings related to the business operations. This need to balance an individuals personal life with the increasing demand for business meetings is a problem being addressed by business and industry. The present invention offers one solution via a novel approach to conventional calendar scheduling.

### SUMMARY OF THE PRESENT INVENTION

The present invention provides an implementation for enabling an invitee who is receiving invitations to meetings, usually via telecommunications, to predetermine a set of invitee-specific attributes that will be applied to each invitation and relate the attributes of the invitation to the specific needs of the invitee in the determination of whether the proposed meeting may be scheduled on the specific invitee's calendar.

In accordance with the present invention, a method for the scheduling of meetings via a network of computer controlled user interactive display stations on the calendars of invitee users is provided that comprises prompting an inviter at a sending display station to enter into an invitation a predetermined general set of attributes for scheduling a meeting. The inviter/host of the meeting may then be enabled to enter into the invitation attributes relative to selected invitees.

The present invention further enables each invitee or any participant in the process who is a potential invitee to predetermine a set of invitee-specific attributes applicable for each invitation to that invitee who has predetermined his or her specific attributes. Each invitee or potential invitee is, thus, enabled to prioritize each predetermined general attribute and each invitee-specific attribute to determine the priority of any meeting on the invitee's calendar. Thus, when an invitation is received, the process may correlate both the invitee's prioritization of the inviter's general attributes and the invitee's prioritization of the invitee-specific attributes to determine the priority and scheduling of the invited meeting on invitee's calendar.

In accordance with a particular aspect of the invention, the inviter is prompted, via an interactive displayed dialog, to enter values for each of the predetermined sets of general attributes, and each of said invitees is enabled to determine the priority of said meeting on the invitee's calendar based upon said attribute values entered by the inviter. Similarly, each of said invitees is prompted via an interactive displayed dialog to enter values for each of their invitee-specific attributes, wherein each of said invitees is enabled to determine the priority of said meeting on the invitee's calendar based upon a correlation of said attribute values entered by the inviter with said values entered by said invitee for said invitee-specific attributes.

In accordance with another aspect of the invention, because business and commerce are conducted on a global scale, there may be a 1 to 23 hour time of day differential between any of the inviters and invitees to a telecommunication meeting. Thus, there is a predetermined time of day attribute that each of the invitees is enabled to predetermine the invitee-specific attributes prioritized to preclude a meeting being scheduled on invitee's calendar when said time of day attribute has invitee-specified values.

The present invention is particularly applicable to a situation wherein the inviter is associated with an organization and a scheduling invitee applying said set of invitee-specific attributes is a work-from-home employee of the organization. Under such circumstances, the set of invitee-specific attributes would include attributes related to home related responsibilities of said employee.

The invention may particularly relate to a situation wherein one of the predetermined sets of general attributes relates to a number of invitees, and at least one of the invitee-specific attributes involves the value of the inviter attribute related to the number of attendees.

Similarly, the invention may relate to situations wherein predetermined sets of general attributes relate to the type of meeting being scheduled, and at least one of the invitee-specific attributes involves the value of said type of meeting attribute.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion, illustrating the global relationship between the inviter and numerous invitees;

FIG. 2 is a illustrative diagrammatic view of a computer system that may be used for any of the computer controlled network terminals from which an inviter may send invitations and invitees may receive such invitations;

FIG. 3 is a general illustration of a computer controlled user interactive terminal display screen on which the inviter is prompted to enter values for predetermined general attributes for the invited meeting;

FIG. 4 is a general illustration of a computer controlled user interactive terminal display screen on which any potential invitees to a meeting may set up a set of invitee-specific attributes of importance to such invitees in determining priorities for invited meetings;

FIG. 5 is a general illustration of a computer controlled user interactive terminal display screen on which potential invitees are prompted to enter their priorities for both predetermined general invitation attributes and invitee-specific attributes;

FIG. 6 is a general illustration of a computer controlled user interactive terminal display screen on which an invitee may view his meeting calendar showing the priorities generated in accordance with the invention;

FIG. 7 is a general flowchart of a program set up to implement the present invention for determining invitee priorities in the scheduling of meetings; and

FIG. 8 is a flowchart of an illustrative run of the program set up in FIG. 7.

### DETAILED DESCRIPTION OF THE PREFERRED EMBODIMENT

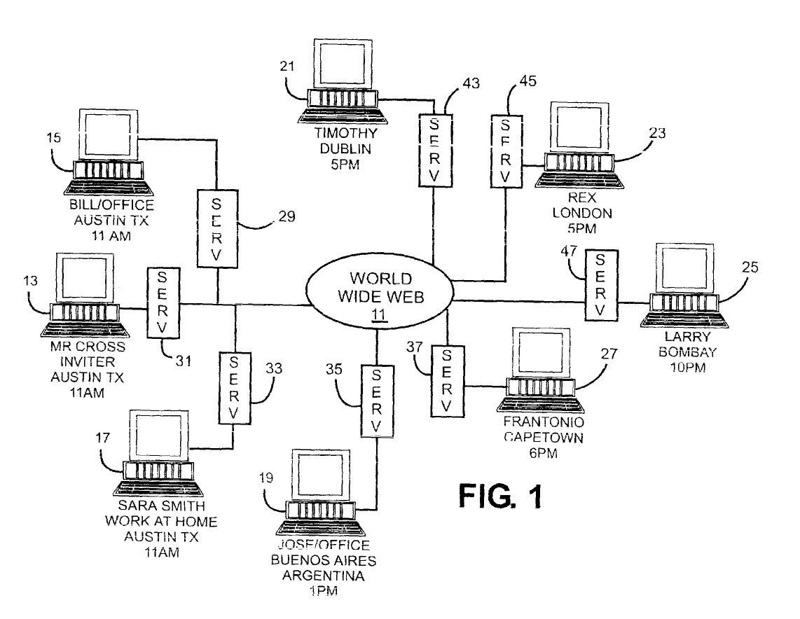

Referring to FIG. 1, there is shown a generalized diagrammatic view of a network portion intended to illustrate the diverse and global nature of a network of users in a business organization that the meeting importance prioritizer and scheduler of the present invention is directed to. The meeting organization is illustrated via telecommunication, e.g. an interactive real-time meeting on-line via email, texting and/or telephone. Thus, the meeting is being set up by the inviter, Mr. Cross, an organization manager, at terminal 13 connected to the Web 11 via Web server 31 in Austin where it is 11 AM. He is to set up the meeting between a diverse group of invitees, including Bill in a nearby office in Austin at terminal 15 connected to the Web via server 29. Also in Austin is Sara Smith, an employee of Cross's organization working at home at terminal 17 connected via server 33. Other invitees include Jose, an employee in an office in Buenos Aires, two time zones removed, at terminal 19 connected via server 35. Six time zones away is Timothy, in an office in Dublin at terminal 21 connected via server 43. Also six time zones away is Rex, in an office in London at terminal 23 connected via server 45. Frantonio, a business partner, at terminal 27 in Capetown is connected via server 37, seven time zones removed. Then there is Larry, an analyst in Bombay at terminal 25, seven time zones away, connected via server 47.

Once the meeting is appropriately organized, the actual meeting may take place on a real-time basis via email on computer display, wireless telephony including email, text messaging, as well as personal presence.

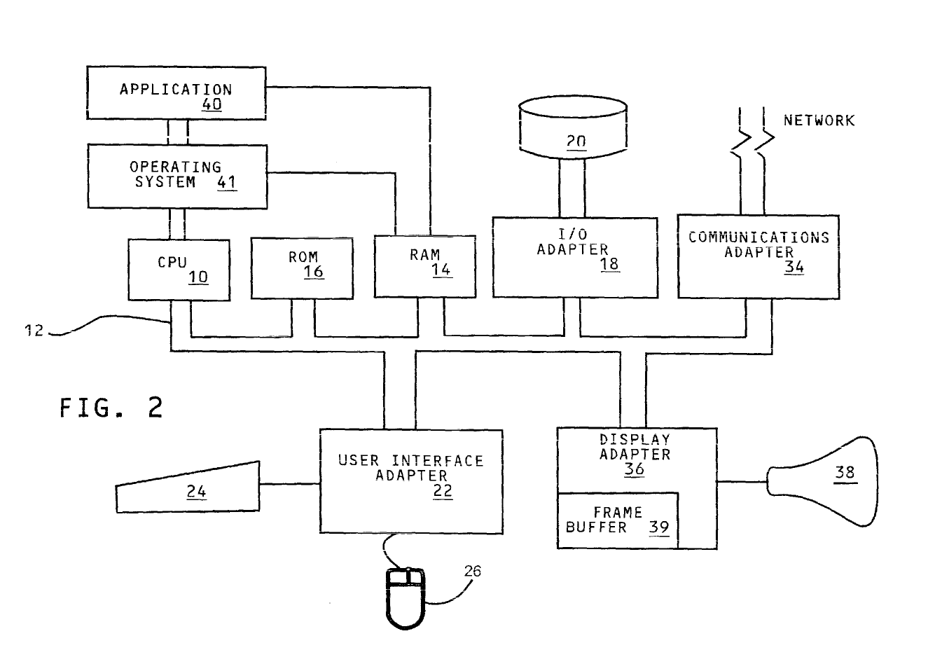

Before going into the computer controlled user interactive display functions involved on the part of the inviter and invitees in the practice of the present invention, there will be described with respect to FIG. 2 an illustrative diagrammatic view of a computer system that may be used for any of terminals 13, 15, 17, 19, 21, 23, 25 and 27 of FIG. 1. A central processing unit (CPU) 10, such as one of the microprocessors or workstations, e.g. System p™ series, or eServerp5 available from International Business Machines Corporation (IBM), is provided and interconnected to various other components by system bus 12. An operating system (OS) 41, e.g. a Linux System, runs on CPU 12, provides control and is used to coordinate the function of the various components of FIG. 2. Operating system 41 may be one of the commercially available operating systems. Application programs 40, controlled by the system, are moved into and out of the main memory Random Access Memory (RAM) 14. These programming applications may be used to implement functions of the present invention. However, it is preferable that the programs used to implement the present invention be in the GUI of the OS 41 connected to CPU 10 via bus 12. ROM 16 includes the Basic Input/Output System (BIOS) that controls the basic computer functions of the hypervisor. RAM 14, storage adapter 18 and communications adapter 34 are also interconnected to system bus 12. Storage adapter 18 communicates with the disk storage device 20. Communications adapter 34 interconnects bus 12 with the outside Web or like network. I/O devices are also connected to system bus 12 via user interface adapter 22. Keyboard 24 and mouse 26 may be connected to bus 12 through user interface adapter 22. Display buffer 39, connected via display adapter 36, supports display 33.

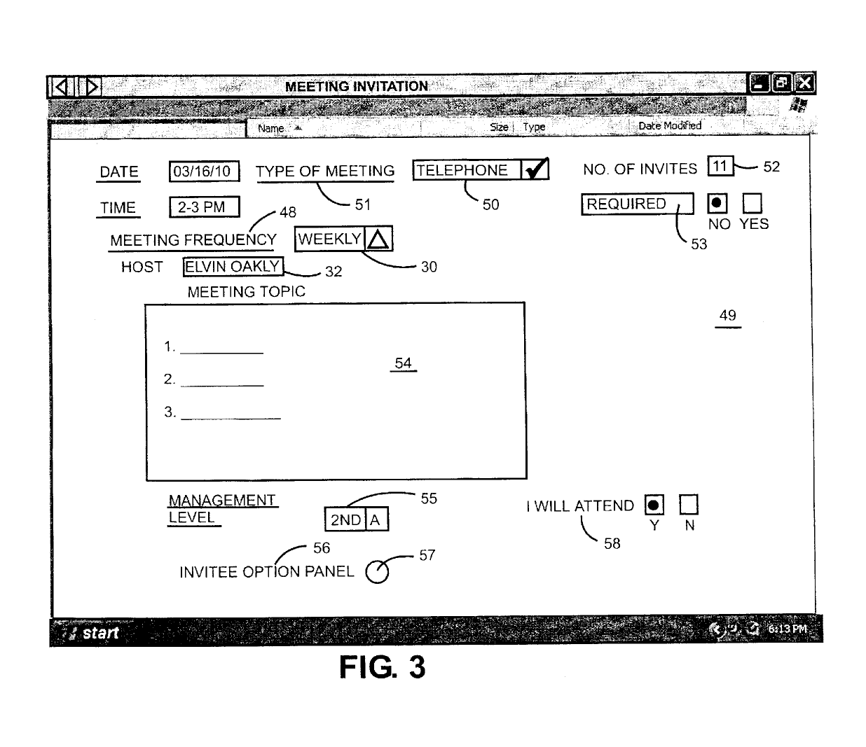

Now with reference to FIGS. 3 through 6 there will be described a sequence of user interface computer controlled interactive display panels for the purpose of decribing how the present invention prompts meeting inviters and invitees to enter and access information enabling an invitee who is receiving invitations to meetings, usually via telecommunication, to predetermine a set of invitee-specific attributes that will be applied to each invitation and that relate the attributes of the invitation to the specific needs of the invitee in the determination of whether the proposed meeting may be scheduled on the specific invitee's calendar. It should be understood that the display screen panels have been simplified for the purpose of illustration, and it should be understood by those skilled in the art that the principles of the present invention would be applicable to much more complex user display interfaces than those illustrated.

Now, with reference to FIG. 3, the inviter, who is an organization manager, is prompted via the display screen panel 49 to enter data that represents the values for a number of predetemined general attributes. For example, the inviter is prompted via panel 49 to enter values for the following attributes. In addition to the time and day of the meeting, attribute 51, Type of Meeting has its value, e.g. telephone, selected via scroll menu 50; an attribute, “No. of Invitees”, may have its value selected via scroll menu 52. Another attribute, “Meeting Fequency” 48, is selected via scroll menu 30. There is an attribute 53 asking whether the presence of a specific invitee is required that selectively has a Yes/No value for the invitee. The host or inviter's name is listed. The attribute, expected Management Level in attendance is selected via scroll menu 55. The topics are listed 54. Once the manager host 32 enters the data into the panel, the panel on screen 49 may provide the invitation panel sent to and received by the invitee. Once an invitation, including the attribute values entered by the inviter, is generated and received at the Web terminal or receiving station of an invitee, the meeting scheduler of this invention can automatically determine priorities and schedule the meeting when appropriate. The invitee should be advised by the process when such a meeting is automatically scheduled so that the invitee may have an opportunity to override the automatic scheduling under appropriate circumstances.

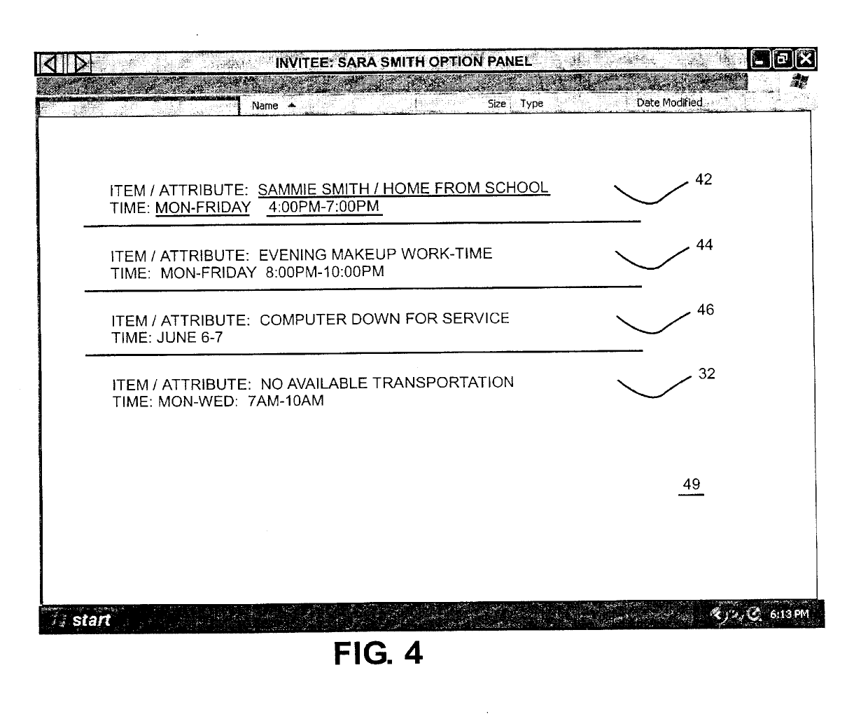

According to one aspect of the invention, the invitation received by the invitee if viewed by invitee can look like and have the information provided by inviter except the values of attributes 50, 52, 53, 48, 55 will be already set. At that point, the invitee will be enabled to decide and advise immediately whether to attend, e.g. the meeting will obviously be significant. In such a case, the invitee may reply via prompt 58. On the other hand, the invitee need not immediately decide and may permit the meeting scheduler to determine the priority of the meeting to the invitees schedule, as will be further described herein. An important element of this invention involves enabling each invitee to predetermine a set of invitee-specific attributes that are applicable to the particular invitee. The invitee may set up such invitee specific attributes and values through the option panel shown in FIG. 4. One way for the invitee to access such a panel is through the selection of button 57, Invitee Option Panel 56. FIG. 4 is an illustrative entry panel wherein an invitee, Sara, who is working from home has an opportunity to set up attribute specific to her at home responsibilities, i.e. invitee-specific attributes. Some illustrations are: item 42, a child home from school with values 4-7 PM, Monday-Friday; item 44, evening makeup work time 8-10 PM, Monday-Friday; item 46, computer terminal down for service June 6-7; and item 32, no available transportation. While this illustration applies to attributes illustrative of a work at home employee, it will be understood that these are just a few examples of the wide variety of activities in which a potential invitee may be involved dependent upon the circumstance and status of the invitee.

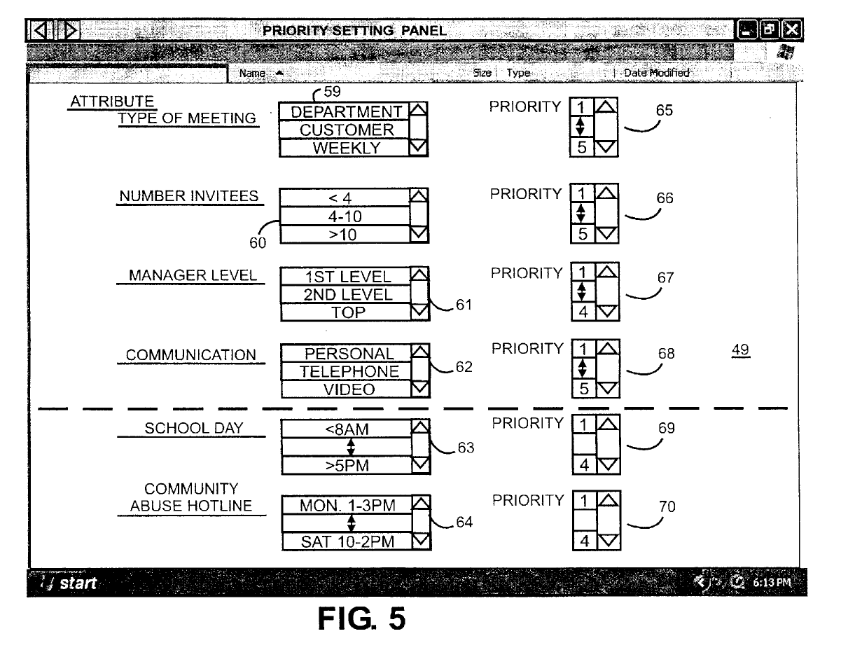

Once a potential invitee has entered the list of invitee-specific attributes, the invitee should then indicate his or her priorities for both anticipated general attributes for an invitation, as well as the invitees priorities for the invitee-specific attributes. The display screen of FIG. 5 is an example of a dialog screen on which potential invitees are prompted to enter their priorities for both predetermined general invitation attributes and invitee-specific attributes so that these priorities may be correlated in determining the relative significance of the invitation to the invitees schedule. Thus, in the example of FIG. 5, first with respect to some anticipated general attributes: one type of meeting, the potential invitee is prompted via scroll menu 59 to select type of meeting, then for each selected meeting type, the invitee is prompted via scroll menu 65 to select a priority level of from 1 to 5. Likewise, on the number of invitees attribute, the potential invitee is prompted via scroll menu 60 to select a number level or range and then for each number or range, the invitee is prompted via scroll menu 66 to select a priority level of from 1 to 5. On the manager level attribute, the potential invitee is prompted via scroll menu 61 to select a manager level and then for each manager level, the invitee is prompted via scroll menu 67 to select a priority level of from 1 to 5. Also, for the communication type used to conduct the meeting, the potential invitee is prompted via scroll menu 62 to select a type, and then for each type, the invitee is prompted via scroll menu 68 to select a priority level of from 1 to 5.

As for examples of invitee-specific attributes, for the school day hours attribute, the potential invitee is prompted via scroll menu 63 to select an hour and then for each hour in the school day, the invitee is prompted via scroll menu 69 to select a priority level of from 1 to 5. Likewise, as the invitee's personal attribute of volunteering on a community abuse hotline, the potential invitee is prompted via scroll menu 64 to select a time period and for each time period the invitee is prompted via scroll menu 70 to select a priority level of from 1 to 5.

As a result of the input in FIG. 5, the process will have the priority levels of several attributes and attribute values covering general meeting attributes and user or invitee-specific attributes. The process may then be used to correlate prioritized attributes in producing invitee calendars. Once the priority levels for all of the attributes are set, the scheduling of meetings, including the resolving of schedule conflicts, may be carried out by priority weighting routines specific to the needs and requirements of the organizations setting up the meetings.

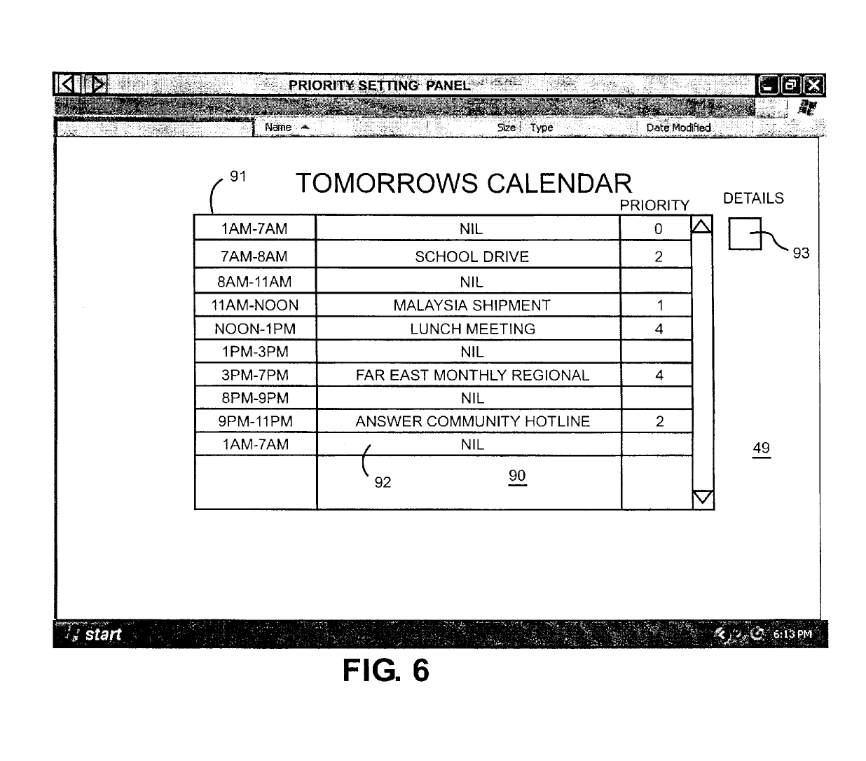

FIG. 6 is a display screen on which an invitee may view his or her meeting calendar showing the priorities generated in accordance with the invention. The scheduled meetings 92 for the day are sequentially arranged along a customary time column 92 with respective priorities shown. If the invitee needs details about a particular meeting, he or she may select the meeting from list 92 and then click on the details button 93.

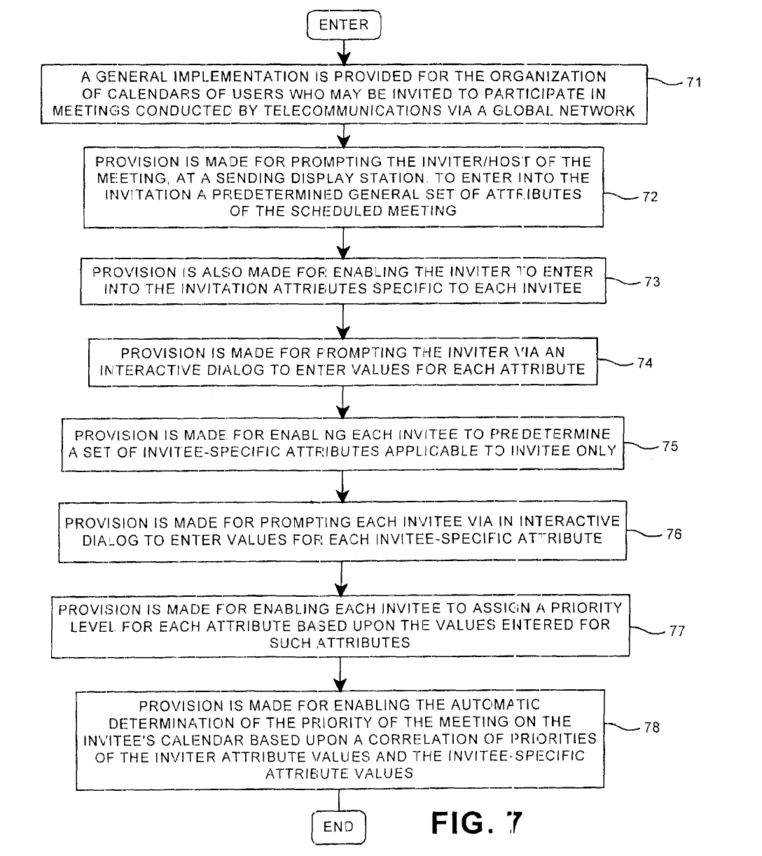

FIG. 7 is a general flowchart of a program set up to implement the present invention for enabling an invitee who is receiving invitations to meetings, usually via telecommunication, to predetermine a set of invitee-specific attributes that will be applied to each invitation.

A general implementation is provided for the organization of calendars of users who may be invited to participate in a meeting conducted by telecommunications via a global network, step 71. Provision is made, step 72, for prompting the inviter/host of the meeting at a sending display station to enter into the invitation being written a predetermined general set of attributes of the scheduled meeting. Provision is also made for enabling the inviter to enter into invitation attributes that the inviter regards as specific to the particular invitee that are relative for the meeting, step 73. Provision is made for prompting the inviter to enter values of each attribute via an interactive dialog, step 74. Provision is made for enabling each potential invitee to meetings to predetermine a set of invitee-specific attributes that will only be relevant to each meeting invitation received by the particular invitee, step 75. Provision is also made for prompting the invitee to enter values for each invitee-specific attribute via an interactive dialog, step 76. Provision is made for enabling each invitee to assign a priority level for each value of attribute from the general set of attributes and the invitee-specific set of attributes to be applied to invitations for meetings received by the invitee, step 77. Provision is made for enabling the automatic determination of the priority of a meeting invitation received by the invitee on the invitee's calendar based upon a correlation of priorities of the inviter's general set of attribute values and the invitee-specific set of attribute values, step 78.

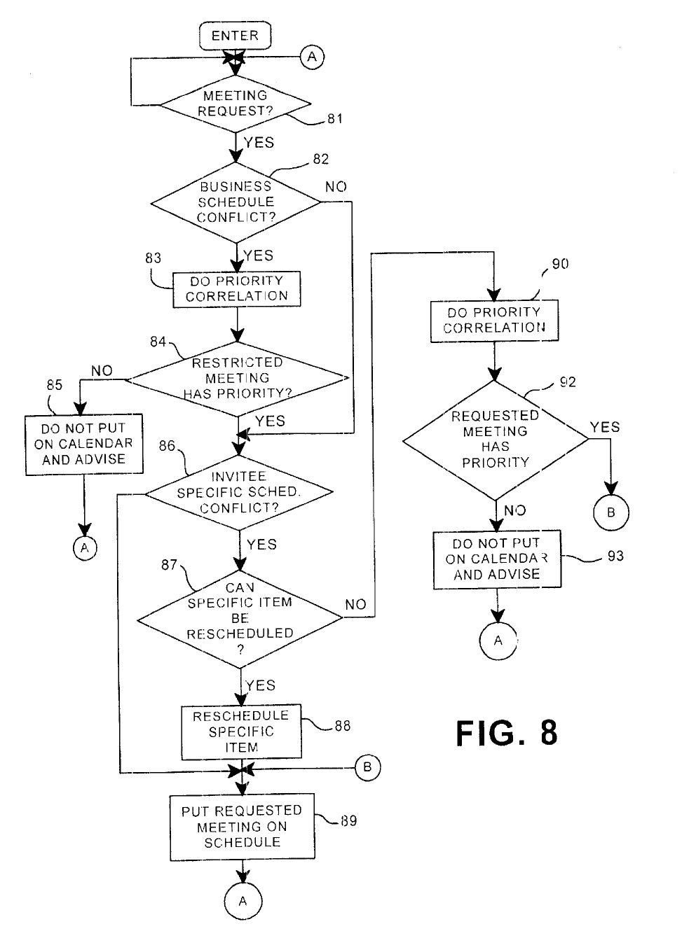

A simple illustrative example of a run of the process set up in FIG. 7 is described with respect to the flowchart of FIG. 8. In the process described above, an initial determination is made at an invitee display station as to whether a meeting invitation has been received, step 81. If Yes, a determination is made as to whether there is any conflict with another business meeting request, step 82. If Yes, a correlation of the invitee priority levels set for attributes is carried out, step 83, and a determination is then made as to whether the invited, i.e. requested, meeting has priority, step 84. If No, the meeting is not scheduled and the inviter is advised in any manner suitable to the process, step 85. If the determination in step 84 is Yes, then a further determination is made as to whether there is a conflict with invitee specific scheduled functions, step 86. If No, the invited meeting is scheduled on the invitee's calendar, step 89. If Yes, there is a further determination made, step 87, as to whether the invitee-specific item can be rescheduled. If Yes, the invitee specific item is rescheduled, step 88, and the invited meeting is scheduled on the invitee's calendar, step 89. If No, then a correlation of the invitee priority levels set for attributes is carried out, step 91, and a determination is then made as to whether the invited, i.e. requested, meeting has priority, step 92. If No, the meeting is not scheduled and the inviter is advised in any manner suitable to the process, step 93. If Yes, the meeting has priority, the meeting is put on the invitee's calendar via branch B to step 89. After steps 85, 89 and 93 the process is returned to step 81 via branch A.

Although certain preferred embodiments have been shown and described, it will be understood that many changes and modifications may be made therein without departing from the scope and intent of the appended claims.

What is claimed is:

1. In a network of computer controlled user interactive display stations, a method for the scheduling of meetings on the calendars of invitee users comprising:
prompting an inviter, at a sending display station, to enter into an invitation a predetermined set of general attributes for the scheduled meeting;
enabling each invitee to predetermine a set of invitee-specific attributes applicable to each invitation; and
enabling each invitee to prioritize each predetermined general attribute and each invitee-specific attribute to determine the priority of said meeting on the invitee's calendar.

2. The method of claim 1, wherein said inviter is prompted, via an interactive displayed dialog to enter values for each of the predetermined sets of general attributes.

3. The method of claim 2, wherein each of said invitees is enabled to determine the priority of said meeting on the invitee's calendar based upon said attribute values entered by the inviter.

4. The method of claim 3, wherein:
each of said invitees is prompted via an interactive displayed dialog to enter values for each of the invitee-specific attributes; and
each of said invitees is enabled to determine the priority of said meeting on the invitee's calendar based upon a correlation of said attribute values entered by the inviter with said values entered by said invitees for said invitee-specific attributes.

5. The method of claim 4 wherein:
there is a 1 to 23 hour time of day differential between any of the inviter and invitees to a telecommunication meeting;
there is a predetermined general time of day attribute; and
each of the invitees is enabled to predetermine an invitee-specific attribute prioritized to preclude a meeting scheduled on invitee's calendar when said time of day attribute has invitee-specified values.

6. The method of claim 4 wherein:
said inviter is associated with an organization;
a scheduling invitee applying said set of invitee-specific attributes is a work-from-home employee of said organization; and
said set of invitee-specific attributes include attributes related to home related responsibilities of said employee.

7. The method of claim 1 wherein:
one of said predetermined sets of general attributes relates to the number of invitees; and
at least one of the invitee-specific attributes involves the value of said inviter attribute related to the number of attendees.

8. The method of claim 1 wherein:
one of said predetermined sets of general attributes relates to the type of meeting being scheduled; and
at least one of the invitee-specific attributes involves the value of said type of meeting attribute.

9. A computer controlled system for the scheduling of meetings on the calendars of invitee users in a network of computer controlled user interactive display stations, comprising:
a processor; and
a computer memory holding computer program instructions, which, when executed by the processor, perform the method comprising:
prompting an inviter at a sending display station to enter into an invitation a predetermined general set of attributes for the scheduled meeting;
enabling each invitee to predetermine a set of invitee-specific attributes applicable to each invitation; and
enabling each invitee to prioritize each predetermined general attribute and each invitee-specific attribute to determine the priority of said meeting on the invitee's calendar.

10. The system of claim 9 wherein the performed method prompts inviter, via an interactive displayed dialog, to enter values for each of the predetermined sets of general attributes.

11. The system of claim 10 wherein the performed method enables each of said invitees to determine the priority of said meeting on the invitee's calendar based upon said attribute values entered by the inviter.

12. The system of claim 11 wherein the performed method prompts each of said invitees, via an interactive displayed dialog, to enter values for each of the invitee-specific attributes; and
enables each of said invitees to determine the priority of said meeting on the invitee's calendar based upon a correlation of said attribute values entered by the inviter with said values entered by said invitees for said invitee-specific attributes.

13. A computer usable storage medium having stored thereon a non-transitory computer readable program for the scheduling of meetings on the calendars of invitee users in a network of computer controlled user interactive display stations, wherein the computer readable program when executed on a computer causes the computer to:
prompt an inviter at a sending display station to enter into an invitation a predetermined set of general attributes for the scheduled meeting;
enable each invitee to predetermine a set of invitee-specific attributes applicable to each invitation; and
enable each invitee to prioritize each inviter-predetermined general attribute and each invitee-specific attribute to determine the priority of said meeting on the invitee's calendar.

14. The computer usable medium of claim 13 wherein the computer program, when executed, prompts the inviter, via an interactive displayed dialog, to enter values for each of the predetermined sets of general attributes.

15. The computer usable medium of claim 14 wherein the computer program, when executed, enables each of said invitees to determine the priority of said meeting on the invitee's calendar based upon said attribute values entered by the inviter.

16. The computer usable medium of claim 15 wherein the computer program, when executed:
prompts each of said invitees via an interactive displayed dialog to enter values for each of the invitee-specific attributes; and
enables each of said invitees to determine the priority of said meeting on the invitee's calendar based upon a correlation of said attribute values entered by the inviter with said values entered by said invitees for said invitee-specific attributes.

17. The computer usable medium of claim 16 wherein there is a 1 to 23 hour time of day differential between any of the inviter and invitees to a telecommunication meeting;
there is a predetermined time of day attribute; and
the computer program, when executed, enables each of the invitees to predetermine an invitee-specific attribute prioritized to preclude a meeting being scheduled on invitee's calendar when said time of day attribute has invitee-specified values.

18. The computer usable medium of claim 16 wherein:
said inviter is associated with an organization;
a scheduling invitee applying said set of invitee-specific attributes is a work-from-home employee of said organization; and
said set of invitee-specific attributes include attributes related to home related responsibilities of said employee.

19. The computer usable medium of claim 13 wherein:
one of said predetermined sets of general attributes relates to number of invitees; and
at least one of the invitee-specific attributes involves the value of said inviter attribute related to number of attendees.

20. The computer usable medium of claim 13 wherein:
one of said predetermined sets of general attributes relates to the type of meeting being scheduled; and
at least one of the invitee-specific attributes involves the value of said type of meeting attribute.
